(19) United States
(12) Patent Application Publication
(10) Pub. No.: US 2018/0288994 A1
(43) Pub. Date: Oct. 11, 2018

(54) Little fire ant killing bait station with access only to tiny insects and providing rain protection for longer effectiveness

(71) Applicants: Darrell Crisp, Hilo, HI (US); David A. Boots, Papaikou, HI (US)

(72) Inventors: Darrell Crisp, Hilo, HI (US); David A. Boots, Papaikou, HI (US)

(21) Appl. No.: 15/731,002

(22) Filed: Apr. 6, 2017

(51) Int. Cl. A01M 1/20

(52) U.S. Cl. CPC A01M 1/2011

(57) ABSTRACT

This invention is the modification of widely available plastic household plumbing caps to serve as poison bait stations for killing colonies of little fire ants which have infested southern states and Hawaii creating misery for residents due to their bites. The modification consists of inserting into the caps metal screens with wire spacing adequate to allow passage of the tiny ants into the caps but preventing the bait granules from falling out. The bait stations so formed restrict the poison bait access to little fire ant or smaller insects and are protective of the environment and animals.

### CROSS-REFERENCE TO RELATED APPLICATIONS

This Utility Patent application was preceded by a Provisional Patent application No. 62/497,441, filing date Nov. 21, 2016, the first named inventor is Darrell Crisp. The title of the invention is Little Fire Ant Killing Bait Station with Access Only to Tiny Insects and Providing Rain Protection for Longer Effectiveness.

### STATEMENT REGARDING FEDERALLY SPONSORED RESEARCH OR DEVELOPMENT

Not Applicable

### REFERENCE TO SEQUENCE LISTING, ETC

Not Applicable

### BACKGROUND OF THE INVENTION

This Utility Patent application is for a low cost device that will hold poisoned bait to kill colonies of the Little Fire Ant (LFA) that are making many people's lives in Hawaii and southern United States miserable by their stings. The stings hurt (like fire), raise half inch diameter welts, and continue to burn and itch for several days. The ants are a growing problem as they spread their colonies into new territories and affect more residents.

Little Fire Ants (Wasmannia auropunctata) are an invasive species which, when they have become established, can form colonies in the ground, in trees and even in homes. The individual ants are tiny, about 1/16 inches long, and red to reddish brown in color. They prefer localities that receive abundant rainfall. The ant colony is composed of worker ants that forage for food in the area surrounding the colony, worker ants that tend the queens and, most importantly, the queens themselves. There may be multiple cooperative queens in a colony. The queens lay eggs that, when hatched, become new workers. To eliminate an ant colony it is necessary to kill the queens. The most effective way to accomplish this is to make available a poison bait to the foraging worker ants that will carry some of the poison back to the nest where it will be fed to the local workers and the queens who will then die ending the ability to create new ants for the colony. The current method, approved by the Environmental Protection Agency (EPA), of providing the poisoned LFA bait to the foraging worker ants is by broadcasting poisoned corn granules onto the ground surface in the vicinity of the nest. The ants do not eat the corn granules as they are liquid only feeders, they suck the oil from the corn and carry the poison back to the nest where it is fed to the local ant residents. The poisons used in the baits are not instant killers but are delayed killers allowing the poisons time for the ants to return to the nests and feed the residents before they take effect. The use of a pesticide such as an ant bait needs to be approved by the EPA and by state regulators. The bait broadcasting method of LFA control has been approved by the EPA and several commercially available baits are presently registered and acceptable to the EPA. A problem with this bait broadcasting method is that the bait should only be used in dry periods when no rain is expected for several hours. If the bait becomes wet it is unacceptable to the ants. The bait is effective only during dry periods and is spoiled by a rain shower. Another disadvantage of the broadcasting of the insecticide bait is that the insecticide is widely spread into the local environment. Spreading the bait over the ground surface uses a lot of bait and is labor intensive, as is an insecticide spray alternative, making the efforts costly.

A second method of providing poison bait to an ant colony is use of bait stations in which a small quantity of poisoned corn granule bait is contained in a holding device that can be accessed by foraging ants. The bait station method, however, while it has obvious advantages has not been tested for effectiveness on little fire ants by the EPA. EPA approvals are expensive and may take years to accomplish. Bait station use has been approved by the EPA for many varieties of ants but not for the LFAs. There are, however, certain circumstances for use of LFA bait stations which are allowed by the EPA's FIFRA (Federal Insecticide, Fungicide, and Rodenticide Act) guidelines. Use of bait stations may be permitted when they are “solely for personal use” and “only on the user's own property”.

Bait stations for LFA control have many advantages over the broadcast method of control. For instance, if there are tree infestations of LFAs the bait station may be attached directly to the infested tree trunks. For infestations in buildings the bait stations may be applied directly to the external portions of the building where the LFAs enter. Using the much smaller amount of bait contained in a bait station is environmentally “more friendly”. Pet and child resistance to bait access can be provided by the station's design. Access to the bait can be restricted to insects the size of LFAs or smaller, as in this invention, thereby protecting larger insects and animals from the insecticide. We believe the advantages afforded by bait stations will eventually lead to their authorization by the EPA.

The invention that is the subject of this application is an inexpensive bait station that is specifically designed to control Little Fire Ants effectively and in a manner friendly to the environment including animals and children.

### BRIEF SUMMARY OF THE INVENTION

The invention is a modification that can be made to inexpensive Poly Vinyl Chloride (PVC) household plumbing caps (made to seal unused pipes) to enable them to serve as containers for poison bait used to eliminate colonies of Little Fire Ants. The invention is a section of metal screen which is forcibly inserted into and across the open end of the cap and held in place by a short circle cut from PVC pipe whose diameter precisely fits the opening in the cap. This arrangement, when the cap is partially filled with poison bait granules, allows the screen to hold the granules in the cap when the cap is turned so that the open end of the cap is facing downward. The openings in the screen allow access to the bait by Little Fire Ants as they crawl into the cap's open end and through the screen. The cap prevents water from contaminating the bait and allows for a nail to be inserted through the cap to be used to fasten the cap to a tree or other support. The sturdy construction of the PVC caps protects the poison bait from contaminating the environment and denies bait access to animals larger than the 1/16^{th} inch Little Fire Ants.

A variety of PVC plumbing caps allow the invention to form a variety of poison bait stations for sale, some that are prefilled with bait and other bait stations that are refillable as needed by the purchaser and can be sold empty.

### BRIEF DESCRIPTION OF THE SEVERAL VIEWS OF THE DRAWING

FIG. 1 illustrates the conversion of a PVC plumbing cap into a bait station by the invention.

FIG. 2 illustrates a cross section of a PVC cap, prefilled with bait, with the bait station modification in place.

FIG. 3 illustrates a cross section of an empty refillable PVC bait station as modified by the invention.

### DETAILED DESCRIPTION OF THE INVENTION

The invention is based on bait containers made from readily available PVC plastic caps that are widely used in household plumbing to cap unused PVC pipes. These caps are made to seal pipes ranging in size from ⅜ inch to several inches in diameter. Caps for ½ inch or ¾ inch diameter pipes are appropriate for the ant bait container. Two varieties of caps may be readily converted into bait stations with different properties. The two conversions each make use of the invention to be described and fill different applications for control of the Little Fire Ant (LFA). The different bait station configurations will be separately described. The first description will be of a bait station that has been preloaded with poison bait as part of its construction. The second description will be of a bait station empty of bait that can be filled and refilled with bait by its purchaser. The ½ inch caps will be used in the descriptions, the ¾ inch caps would have identical descriptions but different dimension values would be used.

Bait Station Preloaded with Bait

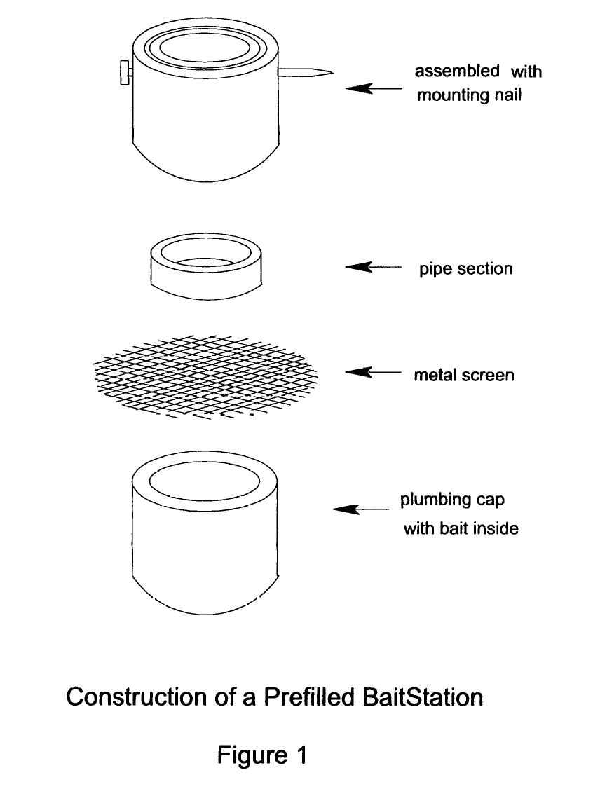

The poisoned corn granule bait is packed into the ½ inch PVC cap until it is approximately ⅝ full. Refer to FIG. 1, a section of metallic screen with wire spacing nominally of 0.083 inches, (for instance aluminum window screen), approximately 1 inch square or circular is centered on top of the cap opening. A section of ½ inch diameter pipe, about ⅜ inches long, is cut from a PVC pipe. This section is placed on top of the metal screen which is on top of the cap partially filled with bait. The pipe section and the underlying screen is forced down into the open end of the plastic cap until the protruding upper edge of the section is even with the opening edge of the cap. A couple of taps with a small hammer encourages the pipe section and screen to fully seat within the cap. The screen holds the bait granules securely in the cap. The amount of bait held in the cap is approximately 1 teaspoon which is adequate for the elimination of two or more LFA colonies. (If a greater amount of bait is desired the next larger cap (¾ inch) could be employed, the construction details would be identical to that just described.) The open end of the cap at this stage of construction will have strands of metallic screening projecting from it. These strand ends are removed by applying the open end of the cap to a disc sander with a medium grit abrasive paper.

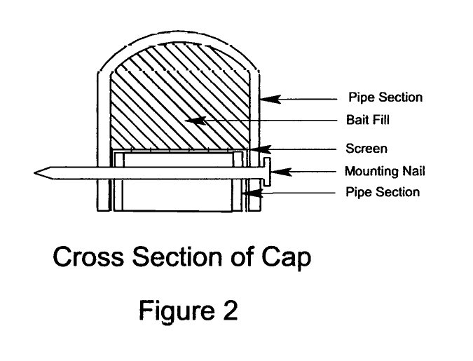

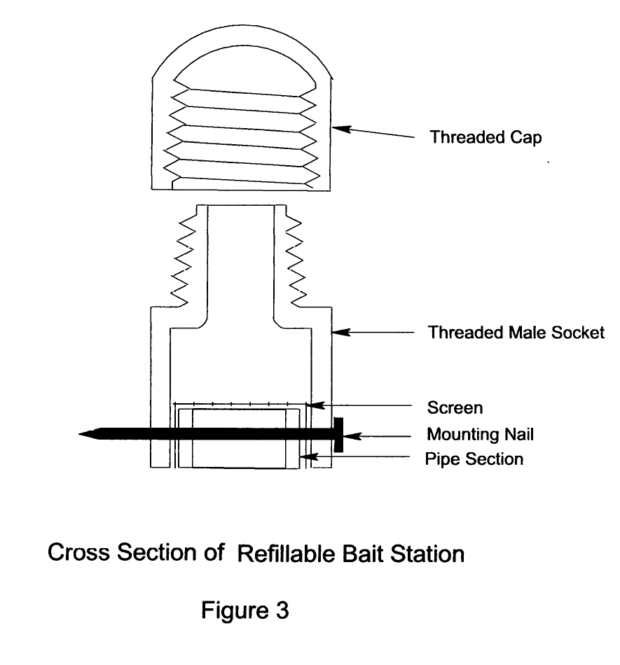

The bait station mounting provision is made by drilling a hole 3/16 inches up the side of the cap from its open end almost entirely through the cap's diameter from one side to the other. This hole is to have a diameter just slightly larger than the diameter of a galvanized box nail 1½ inches long for the ½ inch cap (1¾ inches for a ¾ inch cap), which will be used to mount the cap to a supporting surface. The box nail is inserted into the hole drilled into the cap until the point touches the other end of the hole which was not completely through cap wall. A tap of the hammer on the nail head will force the nail through the thin remaining section of cap. This seats the nail securely in the cap. A gummed circular plastic seal is affixed over the open end of the cap to protect the cap's bait content from contamination by humidity, mold or debris. This completes the assembly of the bait station preloaded with bait. FIG. 2 shows a cross section of the completed bait station without the seal. Note that when mounted to a surface with the open end facing down, rain water is prevented from entering the bait station by the protecting cap and that the holes for the mounting nail are below the bait contained in the cap. In FIG. 2 (and later in FIG. 3) it will appear that the pipe section and screen fit loosely in the lower part of the cap, in fact the fit is tight and no space is present. This drawing choice was made to more clearly illustrate the parts physical relationships.

Application for Tree Infestations

The construction of the bait station allows it to be used directly on tree infestations of the fire ant. Little Fire Ants nesting in a tree forage over the entire tree; limbs, trunk and leaves. They can travel down the trunk to forage on the surrounding ground as well. The bait station is most effectively positioned by nailing it, open side down to protect the bait content from rain, directly to the tree trunk at a height that is convenient for observing the ants entering and leaving the station. If the tree is actually infested with LFAs they will be visible in quantity the day following station installation. Ants leaving the station form a trail going up (and/or down) the trunk. A few days later the ant visitors will be markedly reduced, a few ants will likely still be seen a week later but the colony itself will have been eliminated. If a day after installing the bait station on a tree trunk no fire ants are observed. the tree, probably, was not infected. The bait station can be left installed as protection against infestation for an extended period or it can be moved to another tree.

Application for Ground Infestations

The protection of bait in the station from water contamination also makes it useful for eliminating ant infestations in gardens, lawns and homes. The station can be nailed to shrubs or to near-ground wooden portions of buildings. For open ground areas like gardens and lawns it is suggested that wooden strips, like pop sickle sticks, be obtained and a hole drilled through one end to accept (tightly) the bait station nail without splitting the wood. The stakes can be placed in the ground so that the open bottom of the station is facing down one or two inches above the surface. The stakes may be placed on a 20 foot spacing around a garden or lawn or other area to prevent ant infestations. Existing ground infestations will likely require station stakes within the infested area itself.

Refillable Bait Station

The refillable LFA bait station employs the invention in an identical manner to that in the prefilled bait station previously described. The principal difference between the prefilled and the refillable bait station lies in the different PVC fitting that is employed. In the case of the refillable bait station the fitting is known, in the plumbing trade, as a “male adapter socket” and provides a threaded opening projection on the socket that can be closed with a threaded cap. This socket, modified by the bait station invention, is shown in the cross sectional view provided in FIG. 3. The method of modifying the socket with the invention is identical to that described for the prefilled bait station and will not be repeated here. When the socket is filled with the corn granule (or other) bait it will hold, in the ½ inch socket size, two teaspoons of bait which is adequate to eliminate more than two LFA colonies. After filling, the socket is capped with the threaded cap, shown in FIG. 3, which prevents water from entering.

Application for Use

The method of employing the refillable bait station is identical to that of the previously described prefilled station except that the refillable unit is not limited in its continued use by ant consumption of its bait or, for instance, contamination of the bait by mold. Should the bait need to be replaced it is a simple matter to remove the cap, empty the socket of deteriorated bait refill it with fresh bait and replace the cap.

The following are the claim made for this invention:

1. It is the only poison bait station designed specifically for killing little fire ants by incorporating a metallic screen to allow access to the bait only to creatures the size of little fire ants or smaller.

2. It is the only poison bait station constructed with available, inexpensive PVC plumbing fittings to provide sturdy protection against access to the bait by animals, pets or children.

3. It is the only poison bait station utilizing PVC plumbing fittings to protect the bait from water contamination.
